(19) United States
(12) Patent Application Publication
(10) Pub. No.: US 2025/0168285 A1
(43) Pub. Date: May 22, 2025

(54) DATA PROCESSING APPARATUS, STORAGE MEDIUM, AND CONTROL METHOD

(71) Applicant: CANON KABUSHIKI KAISHA, Tokyo (JP)

(72) Inventor: HIROYOSHI IWAYAMA, Kanagawa (JP)

(21) Appl. No.: 18/948,200

(22) Filed: Nov. 14, 2024

(30) Foreign Application Priority Data
Nov. 21, 2023 (JP) 2023-197086

(51) Int. Cl. H04N 1/00; G06F 9/451; G06F 16/16

(52) U.S. Cl. CPC H04N 1/00503; G06F 9/451; G06F 16/168; H04N 1/00408

(57) ABSTRACT

A method of controlling a data processing apparatus, the data processing apparatus including an operating system (OS) and a program that is different from the OS, includes controlling the data processing apparatus, based on information on the OS, to instruct the OS to display a first file selection screen using a file browser function provided by the OS or to display a second file selection screen using a file browser function of the program.

### BACKGROUND

### Field

The present disclosure relates to a data processing apparatus, a storage medium, and a control method.

### Description of the Related Art

In recent years, along with the spread of mobile terminals, the mobile terminals have increasingly been adopted as business terminals by companies. A user can instruct an image processing apparatus, such as a multifunctional peripheral and a printer, to perform printing and scanning from a mobile terminal in which an application for instructing the image processing apparatus to perform processing is installed. For example, the user selects a file from a folder and configures print settings in the application of the mobile terminal, and then transmits a print execution instruction to the image processing apparatus. The image processing apparatus having received the execution instruction performs print processing based on the settings.

For the application to have a function of selecting a file from a folder provided in a storage in the mobile terminal, there are a case where a file browser function is implemented in the application and a case where a file browser function provided by an operating system (OS) is used. Japanese Patent Application Laid-Open No. 2019-008370 discusses a method in which both a file browser function in an application and a file browser function provided by an OS are implemented, and the file browser function to be used is switched based on a user operation.

An existing configuration in which the user switches between the file browser function in the application and the file browser function provided by the OS is troublesome for the user. In addition, the file browser function convenient for the user may be changed due to a change in specifications and the like of the OS.

### SUMMARY

The present disclosure is directed to a file selection method of an application convenient for the user.

According to an aspect of the present disclosure, a method of controlling a data processing apparatus, the data processing apparatus including an operating system (OS) and a program that is different from the OS, includes controlling the data processing apparatus, based on information on the OS, to instruct the OS to display a first file selection screen using a file browser function provided by the OS or to display a second file selection screen using a file browser function of the program.

Further features of the present disclosure will become apparent from the following description of exemplary embodiments with reference to the attached drawings.

### BRIEF DESCRIPTION OF THE DRAWINGS

FIG. 1 is a diagram illustrating a system configuration according to an exemplary embodiment.

FIG. 2 is a block diagram illustrating a hardware configuration of a data processing apparatus.

FIG. 3 is a block diagram illustrating a hardware configuration of an image processing apparatus.

FIG. 4 is a block diagram illustrating a software configuration of the data processing apparatus.

FIG. 5 is a diagram illustrating examples of a screen displayed by an application operating in the data processing apparatus.

FIG. 6 is a diagram illustrating examples of a screen displayed by the data processing apparatus.

FIG. 7 is a flowchart illustrating processing for selecting a picture file and issuing a print instruction.

FIG. 8 is a flowchart illustrating processing for selecting a document file and issuing a print instruction.

### DESCRIPTION OF THE EMBODIMENTS

An exemplary embodiment is described in detail below with reference to the accompanying drawings. Note that all combinations of features described in the present exemplary embodiment are not necessarily essential for solving means of the present disclosure.

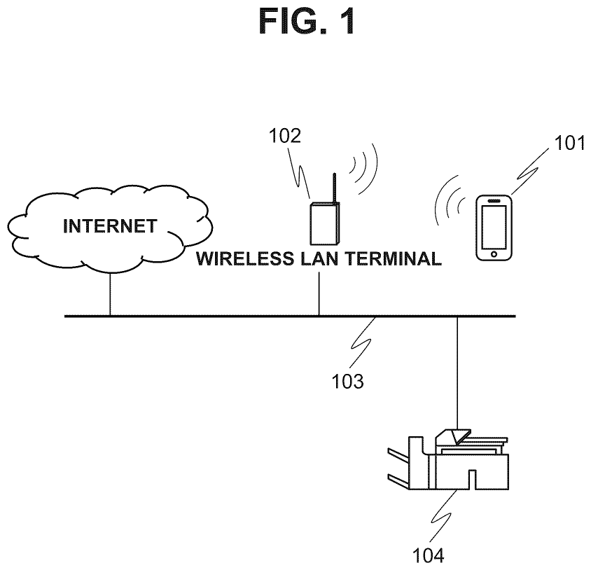

A first exemplary embodiment is described in detail below with reference to the drawings. FIG. 1 is a diagram illustrating a configuration of an information processing system according to the present exemplary embodiment. In FIG. 1, a data processing apparatus 101 is used to transmit a print job and a scan job to an image processing apparatus 104, and receives various kinds of operation from a user. The data processing apparatus 101 is a mobile terminal, such as a smartphone and a tablet. The image processing apparatus 104 may have, in addition to a scan function, a copy function, a print function, a facsimile transmission function, and other functions.

The data processing apparatus 101 and the image processing apparatus 104 are connected to a local area network (LAN) 103, and perform mutual communication through the LAN 103. A wireless LAN terminal 102 is a master unit of a wireless LAN having a general network router function, and provides the wireless LAN in a home, in an office, and the like. The data processing apparatus 101 can participate in the LAN 103 via the wireless LAN terminal 102 by enabling a wireless LAN function. When the data processing apparatus 101 enters a wireless LAN area provided by the wireless LAN terminal 102, the data processing apparatus 101 can automatically participate in the LAN 103 by using authentication information preset in the data processing apparatus 101. The data processing apparatus 101 and the image processing apparatus 104 can also perform direct communication without using the wireless LAN terminal 102. In this example, only one image processing apparatus is illustrated; however, the number of image processing apparatuses is not limited thereto, and a plurality of image processing apparatuses may be connected to the LAN 103.

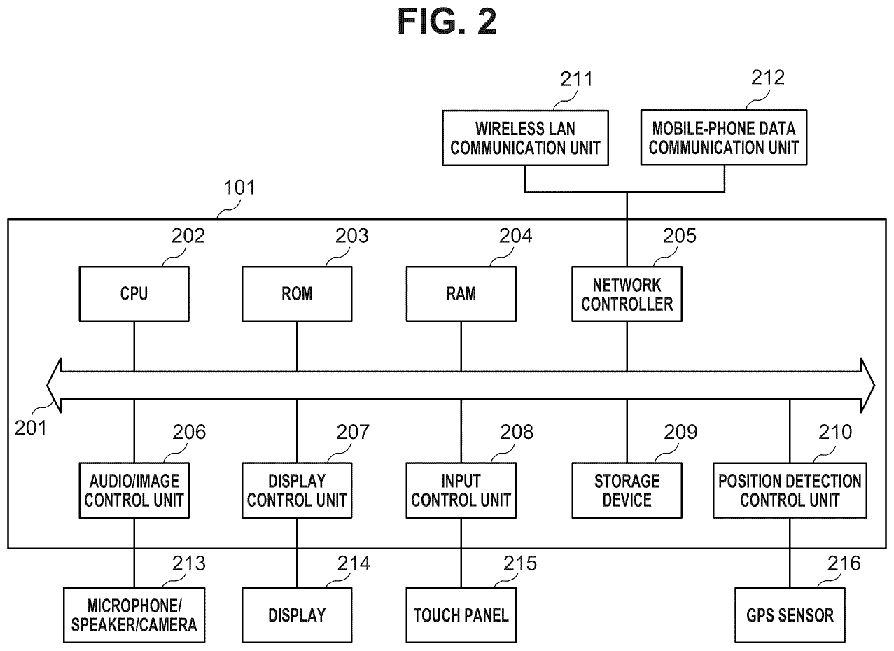

FIG. 2 is a block diagram illustrating a hardware configuration of the data processing apparatus 101 illustrated in FIG. 1. In the data processing apparatus 101, an operating system for a small terminal, and programs controlling call and data communication may operate. Alternatively, the data processing apparatus 101 may be a personal computer (PC) that does not include an audio/image control unit 206, a microphone/speaker/camera 213, a position detection control unit 210, a global positioning system (GPS) sensor 216, a mobile-phone data communication unit 212, and the like described below.

Components of the hardware are connected to a system bus 201. The operating system of the data processing apparatus 101, and applications that control call and data communication are stored in a read only memory (ROM) 203, and can be executed by a central processing unit (CPU) 202. Examples of the application that controls the data communication include an application that exchanges various kinds of data with the image processing apparatus 104, e-mail software, and a web browser.

A random access memory (RAM) 204 is a memory for executing programs, and is a work memory area for the applications to execute the programs. The RAM 204 is also a memory that temporarily stores data and the like to be temporarily saved when the programs are executed by the applications. A storage device 209 is a nonvolatile storage device, and stores various kinds of operation mode settings, operation logs, and the like that are required to be held even after reactivation of the data processing apparatus 101.

A network controller 205 controls communication by a wireless LAN communication unit 211 for participating in the LAN 103 via the wireless LAN terminal 102, and communication by the mobile-phone data communication unit 212 for participating in a network provided by a mobile phone carrier.

The audio/image control unit 206 is used, for example, when a calling application is started up and the user makes a phone call. A microphone and a speaker of the microphone/speaker/camera 213 is used to input and output audio data, and the audio/image control unit 206 mediates between the audio data and an audio data control program. The audio/image control unit 206 also mediates between image data generated by imaging by a camera of the microphone/speaker/camera 213 and an image data control program.

A display control unit 207 controls information to be output by a display 214 of the data processing apparatus 101. An input control unit 208 controls information instructed by the user using a button and a touch panel 215 of the data processing apparatus 101. The applications operating on the data processing apparatus 101 provides network communication information and various kinds of information on the data processing apparatus 101 to the user by using the audio/image control unit 206, the display control unit 207, and the input control unit 208.

The position detection control unit 210 acquires positional information on the data processing apparatus 101 from the GPS sensor 216, and provides the positional information to an operating system (OS). The control is performed by the OS operating in the CPU 202.

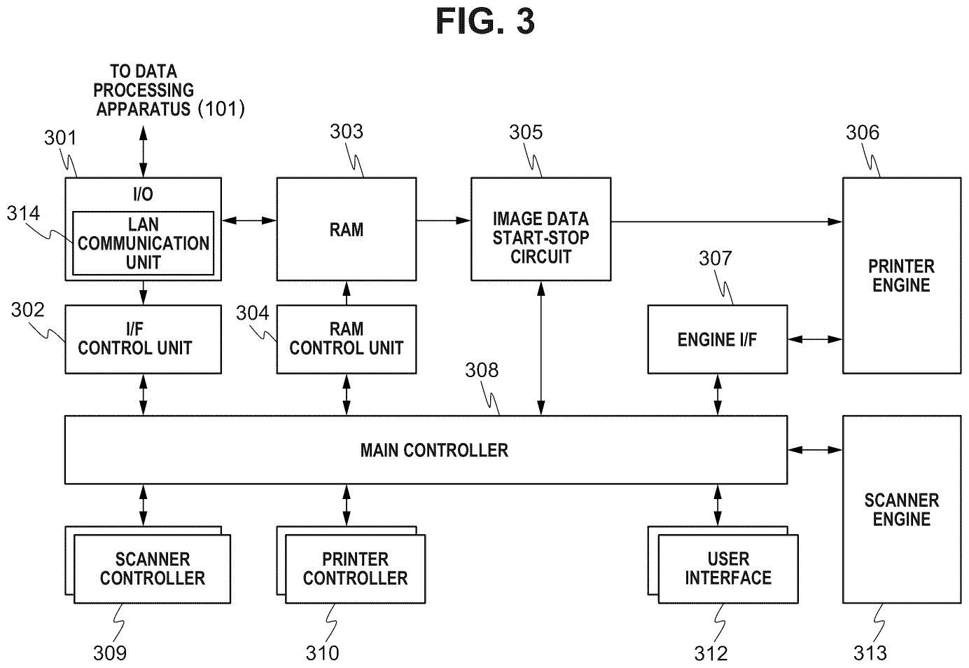

FIG. 3 is a block diagram illustrating a hardware configuration of the image processing apparatus 104 illustrated in FIG. 1. FIG. 3 illustrates an example of a multifunctional peripheral (MFP) having a scanner function and a printer function.

In FIG. 3, an input/output (I/O) 301 includes a LAN communication unit 314. The LAN communication unit 314 can communicate with the data processing apparatus 101 through a network, such as the LAN 103. For example, the LAN communication unit 314 transmits image data generated by scanning by the image processing apparatus 104 to the data processing apparatus 101 through the LAN. A plurality of I/Os 301 may be mounted in order to support a plurality of connection modes. The image processing apparatus 104 transmits a device identification (ID) and a scan image to the data processing apparatus 101 via the I/O 301. The image processing apparatus 104 performs processing in response to various kinds of control commands received from the data processing apparatus 101. An interface (I/F) control unit 302 performs control to issue a device ID to a processing system, such as a scanner, a printer, and a facsimile, mounted on the image processing apparatus 104. A random access memory (RAM) 303 is a primary storage device, and is used to store external data, such as the control command acquired by the I/O 301, and image data (hereinafter, referred to as an image) read by a scanner engine 313. Further, the RAM 303 is used to store an image that is developed by a printer controller 310 and yet to be passed to a printer engine 306. Allocation management of the RAM 303 is performed by a RAM control unit 304. An image data start-stop circuit 305 is a device that outputs the image developed by the printer controller 310 and an image taken in by the scanner engine 313 and developed to the RAM 303, in synchronization with rotation of the printer engine 306. The printer engine 306 is a device that develops an image to an output medium, such as paper. A main controller 308 performs various kinds of control of the printer engine 306 via an engine I/F 307. The main controller 308 is a main module for control, and appropriately distributes a control language received from the data processing apparatus 101 via the I/O 301 to a scanner controller 309 and the printer controller 310. Further, the main controller 308 controls the printer engine 306 and the scanner engine 313 in response to instructions from respective controllers and a user interface 312. The scanner controller 309 decodes a scan control command received from the data processing apparatus 101 into internal execution commands interpretable by the main controller 308. Further, the scanner controller 309 changes an image read by the scanner engine 313 to a scan control command. The printer controller 310 decodes a page description language (PDL) received as a print job from the data processing apparatus 101 into internal execution commands including a developed image interpretable by the main controller 308. The developed image is transmitted to the printer engine 306, and is printed on an output medium, such as a sheet.

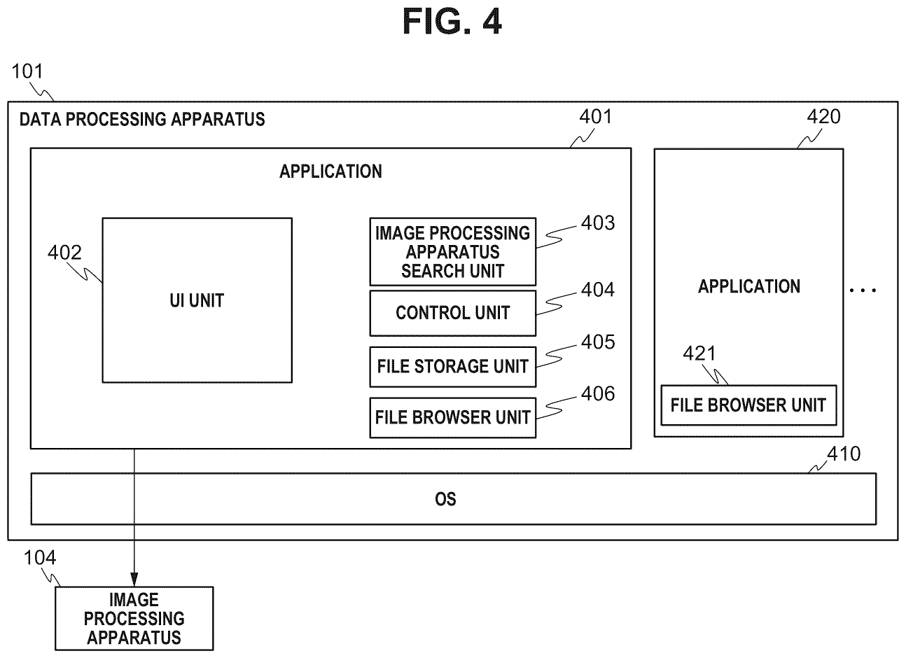

FIG. 4 is a block diagram illustrating a software configuration of the data processing apparatus 101 illustrated in FIG. 1. Processing performed by constituent units are implemented by the CPU 202 executing programs stored in the ROM 203, the storage device 209, and the like.

An OS 410 is basic software that controls operation of the entire data processing apparatus 101. The OS 410 is, for example, Android™ provided by Google LLC.

An application 401 is executed on the data processing apparatus 101, and is installed as an application operating on the OS 410, in the ROM 203. The application 401 is an application that issues a print instruction and a scan instruction to the image processing apparatus 104. For example, a data file, such as image data, stored in the storage device of the data processing apparatus 101 is selected, and the application 401 instructs the image processing apparatus 104 to print the selected file. The application 401 also has a function of instructing the image processing apparatus 104 to perform scanning, and a function of storing an image captured by a camera of the microphone/speaker/camera 213 provided in the data processing apparatus 101. A user interface (UI) unit 402 is an UI unit for the application 401, and provides a user interface that allows the user to set and perform the functions of the application. An image processing apparatus search unit 403 is a unit that searches for an image processing apparatus, and searches for a network apparatus on the LAN 103 in which the data processing apparatus 101 participates, and for a network apparatus that can perform direct communication. More specifically, the image processing apparatus search unit 403 searches for an image processing apparatus to which the data processing apparatus 101 can issue a print instruction and a scan instruction. A control unit 404 controls various kinds of processing performed by the application 401. For example, the control unit 404 generates a print job and a scan job, and transmits the generated jobs to a communicable image processing apparatus. Further, the control unit 404 performs processing for storing data generated by the application 401, and other processing. A file storage unit 405 stores a file generated or acquired by the application 401, and the like. For example, the file storage unit 405 receives image data generated by scanning by the image processing apparatus 104, from the image processing apparatus 104, and stores the received image data. The data stored in the file storage unit 405 may be stored in a common storage area of the data processing apparatus 101 so that the data can be referred to and used by an application other than the application 401, or may be stored in a storage area specific to the application 401 so that the data cannot be referred to and used by an application other than the application 401.

For example, at initial startup or the like of the application 401, a folder corresponding to the file storage unit 405 is automatically generated. Thereafter, the image data generated by the processing performed by the application 401, for example, image data generated by scanning by the image processing apparatus 104 (scan data) and image data generated by imaging by the camera (capture data) are stored in the generated folder.

A file browser unit 406 enables browsing of files stored in a storage, such as the storage device of the data processing apparatus 101. For example, the file browser unit 406 provides a list of files stored in the storage device 209 in order to allow the user to select print data to be transmitted to the image processing apparatus 104. Such a file browser function may employ, as a method for allowing the user to select a picture, a document file, and the like stored in the data processing apparatus 101 and the like, mainly the following two types of methods.

A first method is a method in which a UI screen of a file list is created in the application to allow the user to select a file. In the method, a vendor or a developer of the application uniquely implements a file browser function. Thus, it is possible to provide a file browser function dedicated to the application. For example, a list of files in a previously designated folder (e.g., a folder used as a default storage destination or a default selection source by the application) can be displayed on a default selection screen. On the other hand, it is necessary to implement a mechanism for accessing a cloud storage, an external memory card, and the like, which requires time and cost for designing. In addition, it is necessary to correct the application every time an application programming interface (API) for accessing the cloud storage, the external memory card, and the like is updated. Thus, a maintenance cost of the application is necessary. In addition, usability may be deteriorated due to a change in a specification of the OS. Hereinafter, the file browser function of the method is referred to as an in-application file browser function, and a screen displayed by the file browser function of the method is referred to as an in-application file selection screen. In other words, the file selection screen using the file browser function of the application is referred to as the in-application file selection screen. The in-application file selection screen is used only by the corresponding application.

A second method is a method using a file browser function provided by the OS. In this case, the application can call the file browser function of the OS, and can acquire a file selected using the file browser function of the OS. Thus, in the application, a file is selected by utilizing a mechanism provided by the OS without implementing a mechanism for accessing an external memory card or the cloud storage. In the method, the file browser function provided by the OS is created based on a premise that the file browser function is called from various applications. Therefore, fine settings dedicated to the application cannot be made. Examples of the file browser function provided by the OS include Photo Picker, which is a picture selection screen provided by Android. Photo Picker extracts files in a predetermined file format (in this example, an image format) from among files stored in the storage, such as the storage device 209 of the data processing apparatus 101, and displays a list of the files. Hereinafter, the file browser function of the method is referred to as an OS-provided file browser function, and a screen displayed by the file browser function of the method is referred to as an OS-provided file selection screen. In other words, the file selection screen using the file browser function provided by the OS is referred to as the OS-provided file selection screen. The OS-provided file selection screen is used by a plurality of applications.

An application other than the application 401 is also installed in the data processing apparatus 101. For example, an application 420 is an application having a function similar to the function of the application 401, and includes a file browser unit 421. The application installed in the data processing apparatus 101 is not limited thereto, and other applications may be installed.

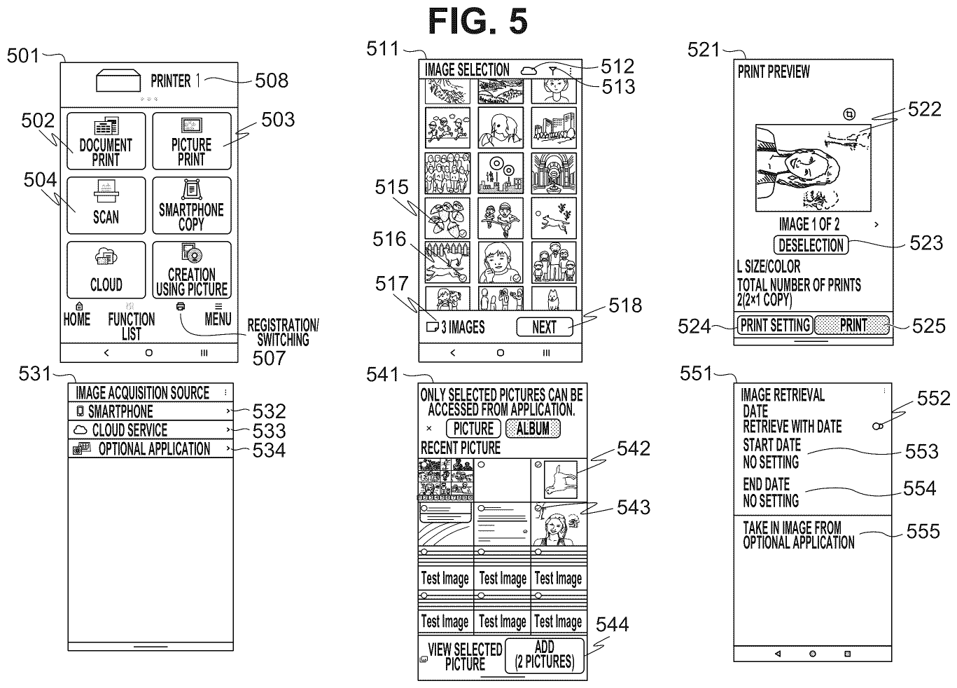

Screen transition from selection of a picture file to be printed to printing of the selected file in the application 401 is described with reference to FIG. 5.

A menu screen 501 is a home screen of the application 401, and is, for example, a top menu screen displayed immediately after the application 401 is started up. On the menu screen 501, the application 401 receives, from the user, a selection operation of a function to be executed. A document print button 502 is a button for instructing the image processing apparatus to print a document. When the document print button 502 is selected, the screen transitions to a screen that is displayed by the processing performed by the file browser unit 406 and on which a document to be printed is selected.

A picture print button 503 is a button for instructing the image processing apparatus to print a picture. When the picture print button 503 is selected, the screen transitions to a screen that is displayed by the processing performed by the file browser unit 406 and on which a picture to be printed is selected.

A scan button 504 is a button for instructing the image processing apparatus to perform scanning. When the user selects the scan button 504, configures various kinds of settings, and then selects a scan execution button, the image processing apparatus performs scan processing, and returns generated image data to the data processing apparatus 101. The file storage unit 405 performs processing for storing the acquired image data in a predetermined folder.

Image processing apparatus information 508 is information on the image processing apparatus that is a target of a print instruction and a scan instruction issued by the application 401. In this example, an icon and an apparatus name of the image processing apparatus are displayed.

A registration/switching button 507 is a button for registering or switching the image processing apparatus to be an instruction target. When the registration/switching button 507 is selected, the image processing apparatus search unit 403 searches for, for example, an image processing apparatus on the LAN 103.

An in-application file selection screen 511 is a screen for selecting a picture file to be printed, and the in-application file selection screen 511 is displayed when the picture print button 503 is selected. The in-application file selection screen 511 is a screen displayed by the file browser function in the application 401, and displays a list of picture files stored in the storage. For example, a list of picture files included in a predetermined folder of the storage device 209 is displayed by default.

A cloud button 512 is a display item for selecting a picture file to be printed from a storage of a cloud. A filter button 513 is a button for changing a condition for filtering files to be displayed in a list and filtering the files to be displayed.

A picture file 515 is a thumbnail of a picture file included in a target folder. A check mark 516 is a display item displayed on the thumbnail so that a picture file selected by the user is identifiable. A number of images 517 is a display item indicating the number of files selected by the user.

When a next button 518 is selected, the screen transitions to a print instruction screen 521. At this time, the file selected by the user in the in-application file selection screen 511 is the file to be printed.

The print instruction screen 521 is a screen for instructing the image processing apparatus to perform printing. An image 522 illustrates a preview image of the file to be printed. In a case where there is a plurality of files to be printed, a next file can be previewed in response to a user operation. A deselection button 523 is a button for deselecting the file to be printed. A print setting button 524 is a button for configuring a setting of printing. A print button 525 is a button for transmitting a print job including the selected file, to a target image processing apparatus.

A picture acquisition source selection screen 531 is a screen for selecting an acquisition source of a picture file to be printed, displayed when the picture print button 503 is selected. When the picture print button 503 is selected, the in-application file selection screen 511 or the picture acquisition source selection screen 531 is displayed depending on a condition. For example, in a case where a version of Android is 14 or later, it is necessary for the application to acquire permission of the user for each file in order to access a file in the storage. In other words, in a case where the version of Android is 14 and a file is selected in the in-application file selection screen 511, it is necessary for the user to perform an operation of giving the permission every time the user selects a file, which is troublesome. On the other hand, in a case where a file is selected in the OS-provided file selection screen, user's permission is not required every time the user selects a file. Therefore, a version of OS (Android) of the data processing apparatus in which the application 401 operates is determined, and when the version is earlier than 14, the in-application file selection screen 511 is displayed in response to selection of the picture print button 503. When the version is 14 or later, the picture acquisition source selection screen 531 is displayed in response to the selection of the picture print button 503. In other words, when the above-described limitation on file access from the application is absent by the specification of the OS, the in-application file selection screen 511 that is a file selection screen with high usability is provided, whereas when the limitation on file access from the application is present by the specification of the OS, the OS-provided file selection screen is used via the picture acquisition source selection screen 531, which eliminates necessity of requiring the user to perform the operation of giving the permission every time. Depending on the specification of the OS, file access from the application may be limited, but the application may be able to access all files by acquiring user's permission only once in some cases. In a case where it is sufficient to acquire the user's permission only once as described above, the in-application file selection screen may be provided, or the OS-provided file selection screen may be provided.

Description is again provided with reference to FIG. 5. The picture acquisition source selection screen 531 includes a smartphone button 532 for setting an acquisition source of a picture file to the data processing apparatus 101, a cloud service button 533 for setting the acquisition source of the picture file to a cloud service, and an optional application button 534 for setting the acquisition source of a picture file to an application different from the application 401.

An OS-provided file selection screen 541 is a screen for selecting a picture file to be printed, displayed when the smartphone button 532 is selected. The OS-provided file selection screen 541 is a screen provided by the OS, and is, for example, a screen of Photo Picker provided by Android. A picture file 542 is a thumbnail of a picture file included in a target folder. A check mark 543 is a display item displayed on the thumbnail to identify a picture file selected by the user.

When an addition button 544 is selected, the screen transitions to the print instruction screen 521. At this time, the file selected by the user in the OS-provided file selection screen 541 is the file to be printed. When a print instruction is issued in the print instruction screen 521, a print job including the file selected in the OS-provided file selection screen 541 is transmitted to the image processing apparatus.

A condition setting screen 551 is a screen displayed when the filter button 513 is selected, and is a screen for setting a condition for filtering a file to be displayed on the in-application file selection screen 511.

An example in which a date of generation of a file is set as the condition is illustrated. A date retrieval button 552 is a button for setting a file generation date as the condition for filtering a file to be displayed. When the date retrieval button 552 is enabled, the condition for filtering the file to be displayed is set to the file generation date. A start date 553 and an end date 554 are display items for respectively setting a start date and an end date with regard to the generation date of the file to be displayed. A file generated on a date between the start date 553 and the end date 554 is displayed on the in-application file selection screen 511. Further, a take-in button 555 for taking in a file from an optional application is displayed in the condition setting screen 551. In a case where the take-in button 555 is selected, the file taken in from the optional application can be printed. As described above, in the in-application file selection screen 511, application-specific browser functions, such as filtering with date to obtain a file to be displayed and accessing the cloud, can be provided. On the other hand, the OS-provided file selection screen 541 cannot provide the unique browser functions, such as filtering with date. In this example, the filtering with date is described as the application-specific browser function; however, the function is not limited thereto. The files in the list may be sorted based on the generation date, or a file name, a file size, and the generation date may be displayed in addition to the thumbnail of the file.

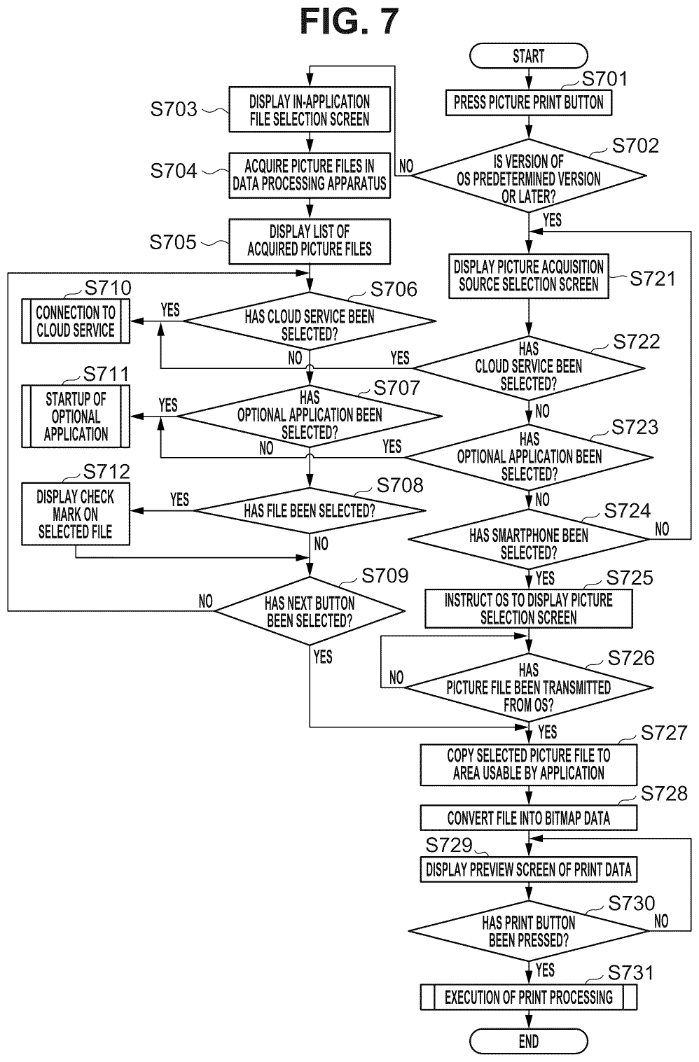

Processing for selecting a picture file to be printed, and printing the selected file in the application 401 is described with reference to a flowchart illustrated in FIG. 7. Steps illustrated in FIG. 7 are implemented by the CPU 202 executing programs stored in the ROM 203 and the storage device 209.

In step S701, the UI unit 402 receives a press on the picture print button 503. In step S702, the control unit 404 acquires the version of the OS on which the application 401 operates, namely, the version of the OS operating in the data processing apparatus 101, and determines whether the acquired version is a predetermined version or later. In a case where it is determined that the acquired version is the predetermined version or later (YES in step S702), the processing proceeds to step S721. Otherwise (NO in step S702), the processing proceeds to step S703. For example, in a case where the version of the OS is Android 14 or later, the processing proceeds to step S721. In a case where the version of the OS is a version earlier than Android 14, the processing proceeds to step S703. In this example, the version of the OS is used for determination; however, the configuration is not limited thereto. For example, it may be determined whether there is a predetermined limitation on access to a file by the OS.

In step S703, the file browser unit 406 displays the in-application file selection screen. In step S704, the file browser unit 406 acquires picture files included in, for example, the storage device 209 of the data processing apparatus 101. In step S705, the file browser unit 406 displays a list of acquired picture files. For example, the in-application file selection screen 511 is displayed.

In step S706, the control unit 404 determines whether an instruction for selecting a file from the cloud has been received from the user. For example, it is determined whether the cloud button 512 has been selected. In a case where the cloud button 512 has been selected (YES in step S706), the processing proceeds to step S710. In a case where the cloud button 512 has not been selected (NO in step S706), the processing proceeds to step S707. In step S710, the control unit 404 establishes connection with a cloud service, and receives user's operation for selecting a file from a list of files stored in a storage of the cloud. In a case where the operation for selecting a file has been received, the selected file may be determined as a file to be printed, and the processing may proceed to step S709 or S727.

In step S707, the control unit 404 determines whether an instruction for selecting a file from an optional application has been received from the user. For example, it is determined whether the take-in button 555 has been selected. In a case where the take-in button 555 has been selected (YES in step S707), the processing proceeds to step S711. In a case where the take-in button 555 has not been selected (NO in step S707), the processing proceeds to step S708. In step S711, the control unit 404 starts up the optional application, and receives user's operation for selecting a file from a list of files included in the optional application. In a case where the operation for selecting a file has been received, the selected file may be determined as a file to be printed, and the processing may proceed to step S709 or S727.

In step S708, the control unit 404 determines whether a file has been selected in the in-application file selection screen. In a case where it is determined that a file has been selected (YES in step S708), the processing proceeds to step S712. Otherwise (NO in step S708), the processing proceeds to step S709. In step S712, the UI unit 402 displays the check mark 516 on the thumbnail of the file selected in step S708. The processing then proceeds to step S709.

In step S709, the control unit 404 determines whether the next button 518 has been selected in the in-application file selection screen. In a case where the next button 518 has been selected (YES in step S709), the processing proceeds to step S727. Otherwise (NO in step S709), the processing returns to step S706.

In step S721, the UI unit 402 displays the picture acquisition source selection screen 531. In step S722, the control unit 404 determines whether the cloud service button 533 has been selected in the picture acquisition source selection screen 531. In a case where the cloud service button 533 has been selected (YES in step S722), the processing proceeds to step S710. Otherwise (NO in step S722), the processing proceeds to step S723. In step S723, the control unit 404 determines whether the optional application button 534 has been selected in the picture acquisition source selection screen 531. In a case where the optional application button 534 has been selected (YES in step S723), the processing proceeds to step S711. Otherwise (NO in step S723), the processing proceeds to step S724. In step S724, the control unit 404 determines whether the smartphone button 532 has been selected in the picture acquisition source selection screen 531. In a case where the smartphone button 532 has been selected (YES in step S724), the processing proceeds to step S725. Otherwise (NO in step S724), the processing returns to step S721.

In step S725, the file browser unit 406 instructs the OS 410 to display the OS-provided file selection screen. For example, herein, the file browser unit 406 instructs the OS 410 to display a screen of Photo Picker.

In step S726, the control unit 404 determines whether a picture file has been transmitted from the OS 410. In a case where a picture file has been transmitted (YES in step S726), the processing proceeds to step S727. Otherwise (NO in step S726), the processing in step S726 is repeated. When the user selects a file and then selects the addition button 544 in the OS-provided file selection screen 541, the selected file is transmitted from the OS 410 to the application 401.

In step S727, the control unit 404 copies the picture file selected by the user to a memory area usable by the application 401. In step S728, the control unit 404 converts the selected picture file into bitmap data. Then, in step S729, the UI unit 402 displays a preview screen of the selected file. In step S730, the control unit 404 determines whether the print button 525 has been selected. In a case where the print button 525 has been selected (YES in step S730), the processing proceeds to step S731. Otherwise (NO in step S730), the processing returns to step S729.

In step S731, the control unit 404 transmits a print job including the file selected by the user to the target image processing apparatus 104. The image processing apparatus 104 having received the print job prints the picture file selected by the user, based on a print setting included in the print job.

By the processing in the above-described flowchart, when the version of the OS of the data processing apparatus 101 is a version earlier than a predetermined version and file access is not limited, the in-application file selection screen is displayed to provide the user with the user-friendly file browser function. When the version of the OS is a predetermined version or later and the file access is limited, the OS-provided file selection screen is displayed, so that the user can avoid a laborious process of giving permission and approval every time the user selects a file. In other words, it is possible to provide the suitable file selection screen based on the information on the OS on which the application operates.

In the example of the above-described flowchart, the version of the OS is determined in step S702; however, the configuration is not limited thereto. For example, it may be determined whether the OS can display the screen of Photo Picker. In a case where the OS can display the screen of Photo Picker, the processing proceeds to step S721. In a case where the OS cannot display the screen of Photo Picker, the processing proceeds to step S703. The OS does not support Photo Picker depending on the version of the OS. Therefore, the suitable file selection screen can be provided based on the determination. In addition, the configuration is not limited to the configuration in which it is determined whether the OS can display the screen of Photo Picker, and it may be determined whether the file browser function provided by the OS is available.

In the example of the above-described flowchart, the file browser unit 406 instructs the OS 410 to display the OS-provided file selection screen in step S725; however, the configuration is not limited thereto. The file browser unit 406 may call a picture selection application of the data processing apparatus 101. The picture selection application is, for example, Google Photo®. A file selected in the picture selection application may be received in step S726.

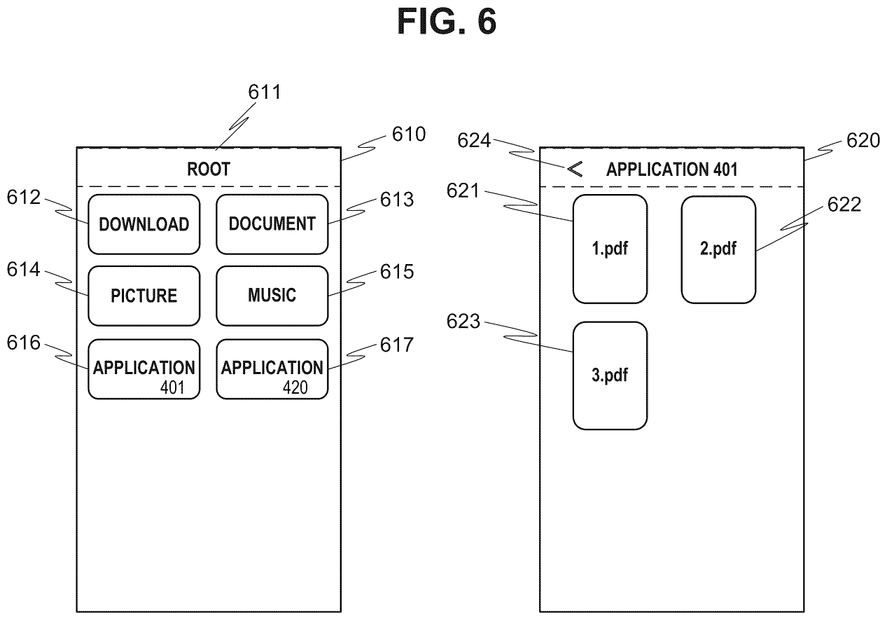

FIG. 6 illustrates examples of a screen in a case where a document file to be printed is selected in the application 401. The screen is displayed when the user selects the document print button 502 in the menu screen 501. When the document print button 502 is selected, a document acquisition source selection screen (not illustrated) is displayed, and the user selects a document file acquisition source. The document acquisition source selection screen has a configuration similar to the configuration of the picture acquisition source selection screen 531. In a case where a cloud service button for setting the document file acquisition source to the cloud service is selected, a document file is acquired from the cloud. In a case where a smartphone button for setting the document file acquisition source to the data processing apparatus 101 is selected, a file selection screen 610 is displayed.

The file selection screen 610 is a file browser screen provided by the OS. Here, a screen of Storage Access Framework (SAF) in Android is illustrated as an example. Unlike the screen of Photo Picker, in the screen of SAF, folders are displayed in hierarchical form in place of a list of picture files included in the storage, and the user selects a folder and a desired file in the folder. In the screen of SAF, a screen opened by default cannot be designated from the application 401. In this example, it is assumed that a “root” directory is opened. A directory name 611 and folders 612 to 617 included in the “root” directory are displayed in the file selection screen 610.

A file selection screen 620 is a screen displayed when an “application 401” folder button 616 is pressed. Data 621 to 623 included in an “application 401” folder, and a return button 624 for returning to a previous directory are displayed in the file selection screen 620. When a file is selected in the file selection screen 620, the screen transitions to a print instruction screen like the print instruction screen 521, and it is possible to instruct the image processing apparatus to print the selected document file. The file selection screens 610 and 620 are screens provided by the OS and are file selection screens using the file browser function of the OS. In the file selection screens 610 and 620, the user's permission is not required every time a file is selected even if the version of the OS is 14 or later.

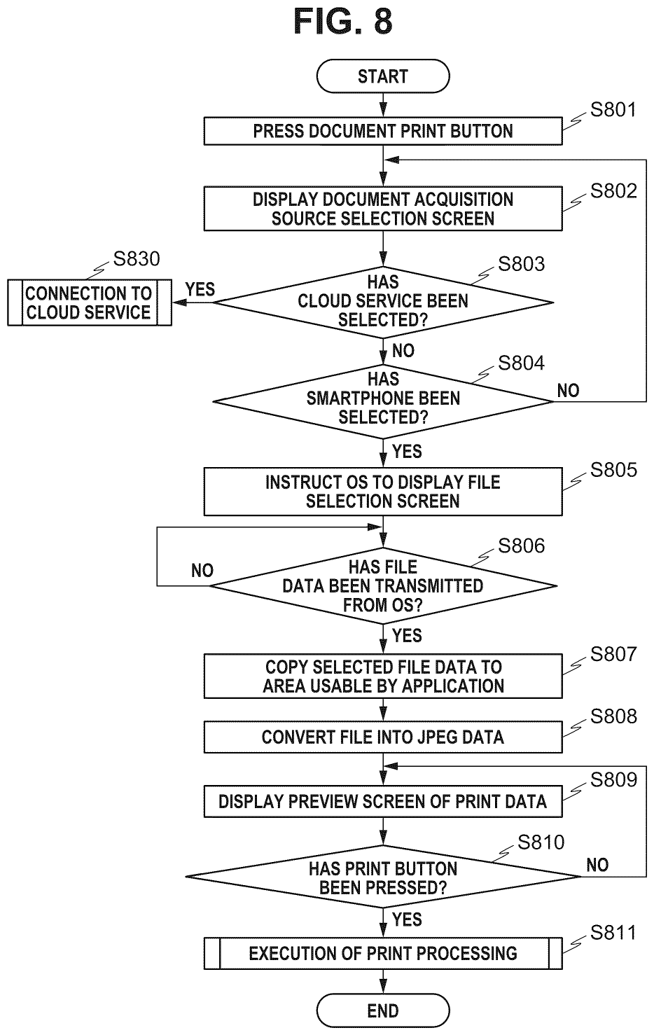

Processing for selecting a document file to be printed, and printing the selected file in the application 401 is described with reference to a flowchart illustrated in FIG. 8. Steps illustrated in FIG. 8 are implemented by the CPU 202 executing programs stored in the ROM 203 and the storage device 209.

In step S801, the UI unit 402 receives a press on the document print button 502.

In step S802, the UI unit 402 displays the document acquisition source selection screen. In step S803, the control unit 404 determines whether the cloud service button has been selected in the document acquisition source selection screen. In a case where the cloud service button has been selected (YES in step S803), the processing proceeds to step S830. Otherwise (NO in step S803), the processing proceeds to step S804. In step S830, the control unit 404 establishes connection with the could service, and receives user's operation for selecting a file from a list of files stored in a storage of the cloud. In a case where the operation for selecting a file has been received, the selected file may be determined as a file to be printed, and the processing may proceed to step S806 or S807.

In step S804, the control unit 404 determines whether the smartphone button has been selected in the document acquisition source selection screen. In a case where the smartphone button has been selected (YES in step S804), the processing proceeds to step S805. Otherwise (NO in step S804), the processing returns to step S802.

In step S805, the file browser unit 406 instructs the OS 410 to display the OS-provided file selection screen. For example, herein, the file browser unit 406 instructs the OS 410 to display the screen of SAF.

In step S806, the control unit 404 determines whether a document file has been transmitted from the OS 410. In a case where a document file has been transmitted (YES in step S806), the processing proceeds to step S807. Otherwise (NO in step S806), the processing in step S806 is repeated. When the user selects a file in the file selection screen 620, the selected file is transmitted from the OS 410 to the application 401.

In step S807, the control unit 404 copies the document file selected by the user to a memory area usable by the application 401. In step S808, the control unit 404 converts the selected document file into JPEG data. Then, in step S809, the UI unit 402 displays a preview screen of the selected file. In step S810, the control unit 404 determines whether the print button 525 has been selected. In a case where the print button 525 has been selected (YES in step S810), the processing proceeds to step S811. Otherwise (NO in step S810), the processing returns to step S809.

In step S811, the control unit 404 transmits a print job including the file selected by the user to the target image processing apparatus 104. The image processing apparatus 104 having received the print job prints the document file selected by the user, based on a print setting included in the print job.

When the file is selected in the case where a document is printed by the processing in the above-described flowchart, the screen of SAF is displayed without exception irrespective of the version of the OS and the like. In the case where the file browser function in the application is used, usability may be deteriorated due to a change in a specification and the like of the OS; however, displaying the screen of SAF without exception makes it possible to prevent deterioration of the usability.

As described above, in the case where a picture is selected, the in-application file selection screen or the OS-provided file selection screen is displayed depending on the version of the OS of the data processing apparatus 101. On the other hand, in the case where a document is selected, the OS-provided file selection screen is displayed without exception irrespective of the version of the OS. However, the configuration is not limited thereto. Both in the case where a picture is selected and in the case where a document is selected, the in-application file selection screen or the OS-provided file selection screen may be displayed depending on the version of the OS of the data processing apparatus 101. Further, both in the case where a picture is selected and in the case where a document is selected, the OS-provided file selection screen may be displayed without exception. In the example of the flowchart illustrated in FIG. 7, the OS-provided file selection screen is Photo Picker, but may be the screen of SAF.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-197086, filed Nov. 21, 2023, which is hereby incorporated by reference herein in its entirety.

What is claimed is:

1. A method of controlling a data processing apparatus, the data processing apparatus including an operating system (OS) and a program that is different from the OS, the method comprising:
controlling the data processing apparatus, based on information on the OS, to instruct the OS to display a first file selection screen using a file browser function provided by the OS or to display a second file selection screen using a file browser function of the program.

2. The method according to claim 1, wherein the information on the OS is information on a version of the OS.

3. The method according to claim 1, wherein the information on the OS is information indicating whether a predetermined file selection screen provided by the OS can be provided.

4. The method according to claim 1, wherein a file displayed on the second file selection screen is filtered based on information on a date of the file.

5. The method according to claim 1, wherein, in a case where a version of the OS is a predetermined version, the OS is instructed to display the first file selection screen, and in a case where the version of the OS is not the predetermined version, the second file selection screen is displayed.

6. The method according to claim 1,
wherein, in a case where a picture file is selected, the information on the OS is used to instruct the OS to display the first file selection screen or display the second file selection screen, and
wherein, in a case where a document file is selected, the OS is instructed to display the first file selection screen using the file browser function provided by the OS irrespective of the information on the OS.

7. The method according to claim 1, wherein, in a case where a button for selecting print data to be printed by an image forming apparatus is selected, when the OS satisfies a predetermined condition, the second file selection screen is displayed, and when the OS does not satisfy the predetermined condition, a screen for selecting a file acquisition source is displayed, and when a predetermined acquisition source is selected in the screen for selecting a file acquisition source, the OS is instructed to display the first file selection screen in the controlling.

8. The method according to claim 1, wherein the OS is Android™.

9. The method according to claim 1, wherein the first file selection screen extracts and displays a picture file.

10. The method according to claim 1, wherein, in the first file selection screen, permission from a user to access a file is not required.

11. The method according to claim 1, wherein the first file selection screen is used by a plurality of applications, and the second file selection screen is used by the program that is a predetermined application.

12. The method according to claim 11,
wherein the predetermined application is a program that instructs an image forming apparatus to perform printing, and
wherein the first file selection screen and the second file selection screen are screens on which print data is selected.

13. The method according to claim 1, wherein the second file selection screen includes a display item for accessing a cloud service.

14. A non-transitory computer-readable storage medium that stores a program including instructions which, when executed by one or more processors of a data processing apparatus including an operating system (OS) that is different from the program, cause the data processing apparatus to perform a control method, the control method comprising controlling the data processing apparatus, based on information on the OS, to instruct the OS to display a first file selection screen using a file browser function provided by the OS or to display a second file selection screen using a file browser function of the program.

15. A data processing apparatus including an operating system (OS) and a program that is different from the OS, the data processing apparatus comprising:
at least one processor, wherein the at least one processor is configured to function as:
a control unit configured to control the data processing apparatus, based on information on the OS, to instruct the OS to display a first file selection screen using a file browser function provided by the OS or to display a second file selection screen using a file browser function of the program.
